(19) United States
(12) Patent Application Publication
(10) Pub. No.: US 2007/0136139 A1
(43) Pub. Date: Jun. 14, 2007

(54) Apparatus and method of protecting user's privacy information and intellectual property against denial of information attack

(75) Inventors: Byeong Cheol Choi, Daejeon-city (KR); Kook Han Kim, Daejeon-city (KR); Jong Ho Ryu, Cheonan-city (KR); Dong Il Seo, Daejeon-city (KR); Jong Soo Jang, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/634,446

(22) Filed: Dec. 5, 2006

(30) Foreign Application Priority Data
Dec. 8, 2005 (KR) 10-2005-0120166
Aug. 31, 2006 (KR) 10-2006-0083569

(51) Int. Cl. G06Q 20/00

(52) U.S. Cl. 705/18

(57) ABSTRACT

Provided are an apparatus and method of protecting a user's privacy information and corporate intellectual property against a denial-of-information (DoI) attack, and more particularly, a privacy & intellectual property protection framework (PIPPF) and a network-based privacy & intellectual property protection system (NPIPPS). The PIPPF includes the NPIPPS and an integrated identity access and management (IAM)/network access control (NAC) solution. The NPIPPS monitors inbound and outbound contents at the network level and prevents the leakage of important information. In addition, the integrated IAM/NAC solution prevents abnormal user activity within a network and unauthorized use of information.

### BACKGROUND OF THE INVENTION

This application claims the priority of Korean Patent Application No. 10-2005-0120166, filed on Dec. 8, 2005, and Korean Patent Application No. 10-2006-0083569, filed on Aug. 31, 2006, in the Korean Intellectual Property Office, the disclosures of which are incorporated herein in their entirety by reference.

### FIELD OF THE INVENTION

The present invention relates to service security of a network system, and more particularly, to a privacy & intellectual property protection framework (PIPPF) against a denial-of-information (DoI) attack and a method of implementing the PIPPF.

### DESCRIPTION OF THE RELATED ART

As the amount of information transmitted through various service communication channels, such as the world wide web (WWW), e-mails, peer-to-peer (P2P) and instant messaging (IM) increases rapidly, there is a growing need for technologies that can counter denial-of-information (DoI) attacks launched using such information.

Examples of DoI attacks include extended enterprise network overseas (XENO) threats using back-end processing, such as P2Ps, recent phishing scams sent through e-mails using social engineering schemes, and pharming through domain spoofing. These DoI attacks cause serious leakage of important personal and corporate information. Therefore, an integrated security framework and system technology which can ward off the illegal leakage and malicious use of personal privacy information and important corporate information is required.

Conventional technologies for guarding against these attacks are available, such as intrusion prevention systems, e-mail monitoring systems, and identity and access management (IAM) solutions and network access control (NAC) solutions. However, intrusion prevention systems mostly concentrate on processing inbound contents or traffic, and e-mail monitoring systems and IAM and NAC solutions mostly concentrate on single service channels.

Therefore, a technology which can configure an integrated security framework at the enterprise network level and prevent inflow of harmful information (inbound filtering) and illegal leakage of information (outbound filtering) at a location between a lead-in point of a network and a service end is required.

A relevant conventional art is disclosed in Korean Patent Application No. 10-2001-0080720, which relates to a Ladon-security gateway system (SGS), a method of setting a security policy, and a method of generating a harmful traffic detection alarm. The Ladon-SGS is designed to counter harmful traffic that illegally invades a system through a network. A security system including a plurality of Ladon-SGSes in a security policy server management network is implemented. However, this conventional art aims to block harmful traffic flowing into a network, and a security gateway controls traffic according to a policy determined by a policy server based on whether the traffic is harmful or not. Hence, the conventional art does not take the service level of normal traffic into consideration nor addresses the problem of illegal leakage of important information.

In this regard, a systematic system and method of not only determining whether traffic is harmful, but also preventing the leakage of personal privacy information and corporate intellectual property at the enterprise network level at a location between a network and a server is required.

### SUMMARY OF THE INVENTION

The present invention provides a privacy & intellectual property protection framework (PIPPF) against a denial-of-information (DoI) attack and a method of implementing the PIPPF in order to prevent the inflow of harmful information (inbound filtering) and the illegal leakage of information (outbound filtering) at the enterprise network level.

According to an aspect of the present invention, there is provided an apparatus for protecting a user's privacy information and intellectual property. The apparatus includes an inbound processing unit determining whether inbound contents are harmful traffic using black lists and blocking the inbound contents based on the determination result; an identity and access management (IAM)/network access control (NAC) solution unit detecting and blocking internal, abnormal user activity and/or a malicious attack, which targets privacy information and intellectual property, using user access control and device access control; and an outbound processing unit preventing the leakage of the privacy information and intellectual property through outbound contents using white lists.

According to another aspect of the present invention, there is provided a method of protecting a user's privacy information and intellectual property. The method includes determining whether inbound contents are harmful traffic using black lists and blocking the inbound contents based on the determination result; detecting and blocking internal, abnormal user activity of a user and/or a malicious attack, which targets privacy information and intellectual property, through user access control and device access control using an IAM/NAC solution; and preventing the leakage of the privacy information and intellectual property through outbound contents using white lists.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates locations at which a privacy & intellectual property protection framework (PIPPF) and a network-based privacy & intellectual property protection system (NPIPPS) are applied;

FIG. 2 illustrates the configuration of a PIPPF according to an embodiment of the present invention;

FIG. 3 illustrates an apparatus for detecting and blocking a denial-of-information (DoI) attack launched through inbound & outbound contents in NPIPPS according to an embodiment of the present invention; and

FIG. 4 is a flowchart illustrating a method of detecting and blocking a DoI attack using a PIPPF according to an embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth therein; rather, these embodiments are provided so that this disclosure will be thorough and complete, and will fully convey the concept of the invention to those skilled in the art.

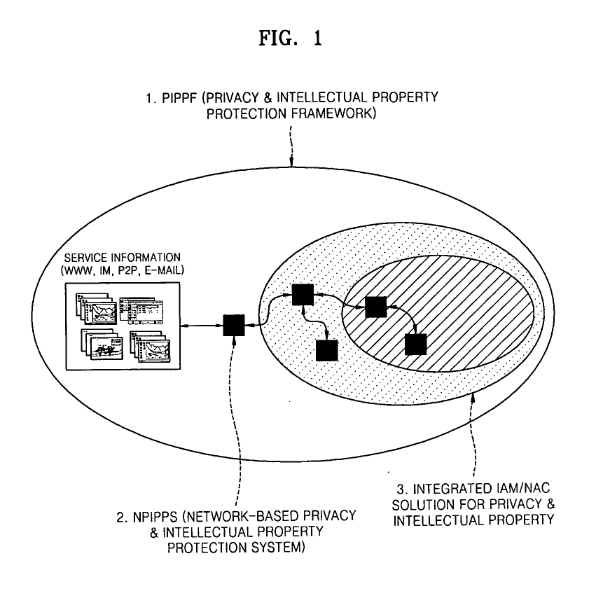

FIG. 1 illustrates locations at which a privacy & intellectual property protection framework (PIPPF) and a network-based privacy & intellectual property protection system (NPIPPS) are applied.

Referring to FIG. 1, the PIPPF includes the NPIPPS and an integrated identity and access management (IAM)/network access control (NAC) solution. The NPIPPS monitors inbound & outbound contents and prevents the leakage of important information at the network level. The integrated IAM/NAC solution prevents abnormal user activity and the unauthorized use of information within a network. The integrated IAM/NAC solution denotes an identity and access management (IAM) and network access control (NAC) solution of a user's account based on an ID and a password. Since the integrated IAM/NAC solution simultaneously controls access of authorized users based on user IDs and access to authorized devices based on device IDs, it can block illegal access using another user's ID or block malicious attacks at their source. Therefore, abnormal activities or illegal use of information can be prevented.

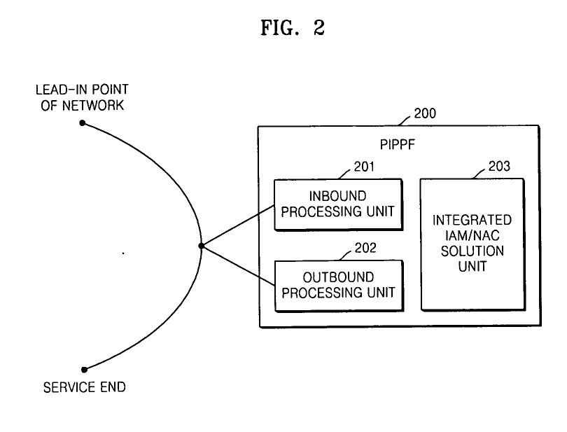

FIG. 2 illustrates the configuration of a PIPPF 200 according to an embodiment of the present invention.

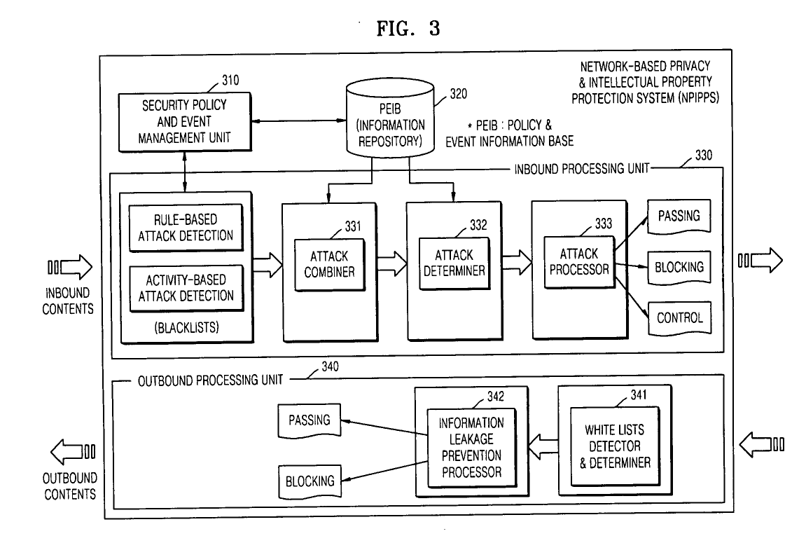

Referring to FIG. 2, the PIPPF 200 is located between a lead-in point of a network and a service end. The PIPPF 200 includes an inbound processing unit 201 detecting and processing harmful information included in inbound contents, an integrated IAM/NAC solution unit 203 detecting and blocking internal, abnormal user activity and a malicious attack, and an outbound processing unit 202 preventing the leakage of important information through outbound contents. The inbound processing unit 201 and the outbound processing unit 202, which are included in an NPIPPS, will now be described with reference to FIG. 3.

FIG. 3 illustrates an apparatus for detecting and blocking a denial-of-information (DoI) attack launched through inbound & outbound contents in NPIPPS according to an embodiment of the present invention.

Referring to FIG. 3, an inbound processing unit 330 determines whether harmful traffic is contained in inbound contents using lists of harmful and malicious information (hereinafter, referred to as checklists or black lists) of NPIPPS. Specifically, the inbound processing unit 330 performs two processes in a broad sense. First, the inbound processing unit 330 detects an attack and determines if the attack is a rule-based attack or an activity-based attack. Second, an attack combiner 331 included in the inbound processing unit 330 combines these determination results and then an attack determiner 332 can determine whether these attacks have been combined and an attack processor 333 processes the attacks based on the determination result. The attack processor 333 processes the attacks by passing, blocking or controlling.

The rule-based attack can be detected using a rule database (DB) created based on existing well-known rules. The activity-based attack is not an existing well-known attack but may be classified as harmful traffic due to an abnormal activity pattern of traffic.

Specifically, when processing inbound contents, the inbound processing unit 330 detects an attack and determines if the attack is the rule-based attack or the activity-based attack in cooperation with a security policy and event management unit 310. Since most of a hacker's attack can be detected and countered only when the two attacks are detected, the attack combiner 331 considers the possibility of a combination of the two attacks, and the attack determiner 332 determines whether an attack has been launched based on the combined attacks. In this case, the attack determiner 332 refers to necessary information stored in a policy & event information base (PEIB) 320. Finally, the attack processor 333 processes the attack through passing, blocking or controlling.

If an attack is an activity-based attack in the form of a rule-based attack, such as a distributed denial-of-service (DDOS) attack or a worm attack, the attack processor 333 blocks the attack by using all means at its disposal. For other types of attacks, the attack processor 333 updates the rule DB and passes or blocks the attacks according to an administration policy.

On the other hand, white lists detector & determiner 341 included in the outbound processing unit 340 determines whether outbound contents are illegally leaked using white lists (list of important information for user or enterprise). Large-volume data attached to outbound contents and leaked accordingly is generally logged. Thus, the outbound processing unit 340 can directly block the illegal leakage of the large-volume data by comparing the log with the white lists. An information leakage prevention processor 342 may determine whether to pass or block the outbound contents.

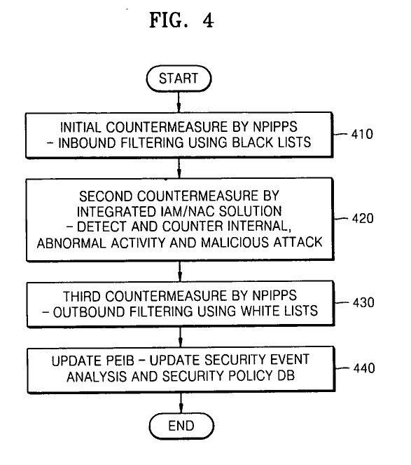

FIG. 4 is a flowchart illustrating a method of detecting and blocking a DoI attack using a PIPPF according to an embodiment of the present invention.

Referring to FIG. 4, the NPIPPS determines whether inbound contents are harmful traffic using black lists (an initial countermeasure, operation 410). Then, the integrated IAM/NAC solution detects and counters an internal, abnormal activity of a user and/or a malicious attack (a second countermeasure, operation 420). In addition, the NPIPPS determines illegal leakage of outbound contents using white lists (a third countermeasure, operation 430). Then, a security event analysis and security policy DB is updated (operation 440).

Specifically, the initial countermeasure includes detecting a rule-based attack and/or an activity-based attack, combining the attacks in order to accurately determine whether an attack has been launched using two attack detection techniques, determining whether the attack has been launched based on the combined attacks, and updating the rule DB based on the determination result and processing the attack by passing, blocking or control.

The third countermeasure includes determining whether the outbound contents have been illegally leaked by comparing a log of the outbound contents with white lists and preventing the illegal leakage of important information by passing or controlling the important information according to a policy of an administrator.

As described above, the preset invention provides a PIPPF and an NPIPPS in order to protect important personal and corporate information. Since the PIPPF includes the NPIPPS and an integrated IAM/NAC solution, it can monitor inbound and outbound contents at the network level and thus prevent the inflow of harmful and malicious information and the illegal leakage of important information. In addition, the PIPPF can prevent abnormal user activity within a network and unauthorized use of information.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

It may be easily understood by those of ordinary skill in the art that each operation included in the present invention can be variously implemented in software or hardware using a general programming technique.

Some operations of the present invention can also be embodied as computer readable codes on a computer readable recording medium. The computer readable recording medium is any data storage device that can store data which can be thereafter read by a computer system.

What is claimed is:

1. An apparatus for protecting a user's privacy information and intellectual property, the apparatus comprising:
an inbound processing unit determining whether inbound contents are harmful traffic using black lists and blocking the inbound contents based on the determination result;
an identity and access management (IAM)/network access control (NAC) solution unit detecting and blocking internal, abnormal user activity and/or a malicious attack, which targets privacy information and intellectual property, using user access control and device access control; and
an outbound processing unit preventing the leakage of the privacy information and intellectual property through outbound contents using white lists.

2. The apparatus of claim 1, wherein the inbound processing unit combines a determination result of a rule-based attack, which can be detected based on a rule database (DB), with a determination result of an activity-based attack, which can be detected based on whether a traffic activity pattern is abnormal, determines whether an attack has been launched based on the combined determination results, and passes, controls or blocks the attack.

3. The apparatus of claim 1, wherein the IAM/NAC solution unit blocks illegal access or the malicious attack by allowing authorized users to have access to authorized devices based on user ID information of each user and device ID information of each device.

4. The apparatus of claim 1, wherein the outbound processing unit prevents the leakage of the privacy information and intellectual property by comparing a log of the outbound contents with the white lists.

5. A method of protecting a user's privacy information and intellectual property, the method comprising:
determining whether inbound contents are harmful traffic using black lists and blocking the inbound contents based on the determination result;
detecting and blocking internal, abnormal user activity of a user and/or a malicious attack, which targets privacy information and intellectual property, through user access control and device access control using an IAM/NAC solution; and
preventing the leakage of the privacy information and intellectual property through outbound contents using white lists.

6. The method of claim 5, wherein the determining of whether the inbound contents are harmful traffic and blocking the inbound contents based on the determination result comprises:
detecting a rule-based attack based on a rule DB and/or an activity-based attack based on whether a traffic activity pattern is abnormal;
determining whether an attack has been launched based on the result of combining the rule-based and activity-based attacks; and
updating the rule DB based on the determination result and passing, controlling or blocking the traffic according to an administration policy.

7. The method of claim 5, wherein the detecting and blocking of the internal, abnormal user activity and/or the malicious attack comprises blocking illegal access or the malicious attack by allowing users to have access to authorized devices based on user ID information of each user and device ID information of each device.

8. The method of claim 5, wherein the preventing of the leakage of the privacy information and intellectual property comprises:
comparing a log of the outbound contents with the white lists and determining whether the privacy information and intellectual property have been illegally leaked; and
passing, controlling or blocking illegally leaked privacy information and intellectual property according to the administration policy.
